(19) United States
(12) Patent Application Publication
(10) Pub. No.: US 2010/0043263 A1
(43) Pub. Date: Feb. 25, 2010

(54) SYSTEM AND METHOD FOR MODULAR ELECTROLUMINESCENT SIGN

(75) Inventor: Aaron J. Golle, Shakopee, MN (US)

Correspondence Address: SCHWEGMAN, LUNDBERG & WOESSNER, P.A., P.O. BOX 2938, MINNEAPOLIS, MN, 55402, US

(73) Assignee: Safe Lites, LLC, Praire, MN (US)

(21) Appl. No.: 12/195,006

(22) Filed: Aug. 20, 2008

(51) Int. Cl. G09F 13/22

(52) U.S. Cl. 40/544

(57) ABSTRACT

The present subject matter includes method and apparatus for attaching electroluminescent (EL) modules including one or more electroluminescent lamps to a billboard. In some embodiments, the modules are posted on a post date that is separate from the post date of the billboard. In some embodiments, the modules include visual indicia that replicate and mask visual indicia of the billboard in a non-illuminated state.

### CROSS REFERENCE TO RELATED APPLICATION

The following commonly assigned U.S. patent application is related and is incorporated by reference in its entirety: “Method and Apparatus for Billboard with Advertisement Including Electroluminescent Lighting,” U.S. patent application Ser. No. 11/999,494, filed on Dec. 4, 2007 (Attorney Docket No. 1748.026US1).

### FIELD OF THE INVENTION

The inventive subject matter relates to method and apparatus for providing outdoor or out-of-home advertising, such as a billboard with media carrying an advertisement, such as one or more images and/or text for the advertisement, wherein there are provided electroluminescent (EL) portions of the advertisement.

### BACKGROUND

Out-of-home advertising, such as billboard advertising, is an important and pervasive advertising medium. Creating imaginative and compelling advertising messages and displays for out-of-home advertising is a constant objective of the advertising industry.

### BRIEF DESCRIPTION OF DRAWINGS

FIGS. 1A and 1B illustrate an illuminated sign for a billboard sign (hereinafter “billboard), according to one example embodiment of the inventive subject matter;

FIGS. 2A, 2B and 3 illustrate apparatus for illuminating a billboard, according to one example embodiment of the inventive subject matter;

FIGS. 4A and 4B illustrate the construction of an EL lamp sign, according to one example embodiment of the inventive subject matter;

FIG. 5 illustrates a housing for an electronics unit for an EL illuminated sign, according to one example embodiment of the inventive subject matter;

FIG. 6 illustrates a sign with registration indications for EL lamp signs, according to one example embodiment of the inventive subject matter;

FIGS. 7 and 8 illustrate apparatus and method for an EL illuminated sign, according to one example embodiment of the inventive subject matter;

FIG. 9 illustrates a method, according to one example embodiment of the inventive subject matter;

FIG. 10 illustrates an application of an EL sign around a curved surface, according to one example embodiment of the inventive subject matter;

FIG. 11A illustrates a billboard, according to some embodiments;

FIG. 11B illustrates a billboard, according to some embodiments;

FIG. 11C illustrates alignment pointers, according to some embodiments;

FIG. 12A illustrates an isometric view of a portion of a billboard, according to some embodiments;

FIG. 12B illustrates a side cross section view of a billboard including an EL lamp shining through an indicium, according to some embodiments;

FIG. 12C illustrates an EL module and an alignment pointer, according to some embodiments;

FIG. 13 illustrates a side cross section view of a billboard including an EL lamp shining through an indicium and affixed to the billboard, according to some embodiments;

FIG. 14 illustrates a side cross section of a billboard including an EL lamp affixed to the billboard, according to some embodiments;

FIG. 15 illustrates a cross section of a billboard, according to some embodiments;

FIG. 16 illustrates a plurality of EL lamps, according to some embodiments;

FIG. 17 illustrates a plurality of EL lamps, according to some embodiments;

FIG. 18 illustrates a method, according to some embodiments; and

FIG. 19 illustrates a method according to some embodiments.

### DETAILED DESCRIPTION OF THE INVENTION

In the following detailed description, reference is made to the accompanying drawings that form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, electrical changes, etc., may be made without departing from the scope of the present invention.

According to one example embodiment, there is provided a system and method for electroluminescent (EL) active illumination for outdoor advertising applications, and, in particular, billboards, according to the inventive subject matter described herein. According to one example embodiment, an EL active illumination system, according to the inventive subject matter described herein, may be designed to complement traditional advertising production.

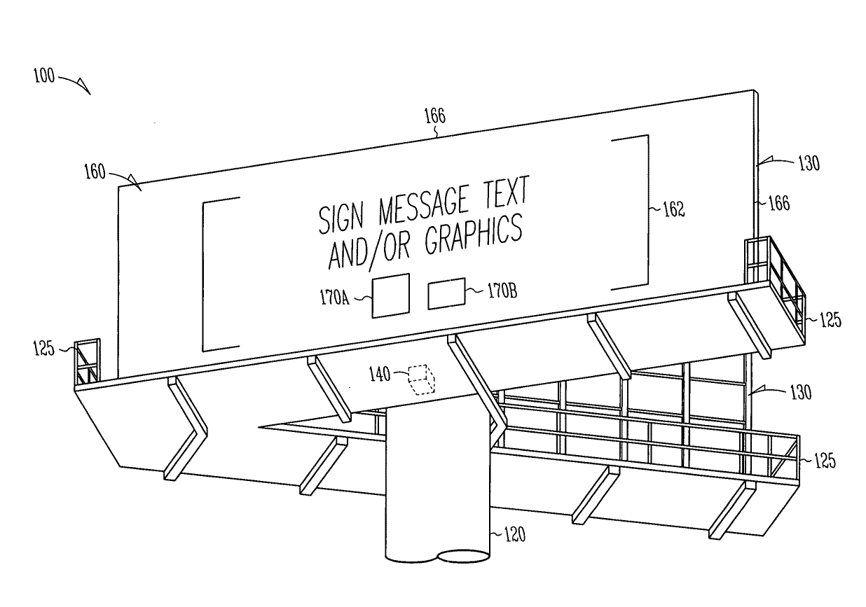

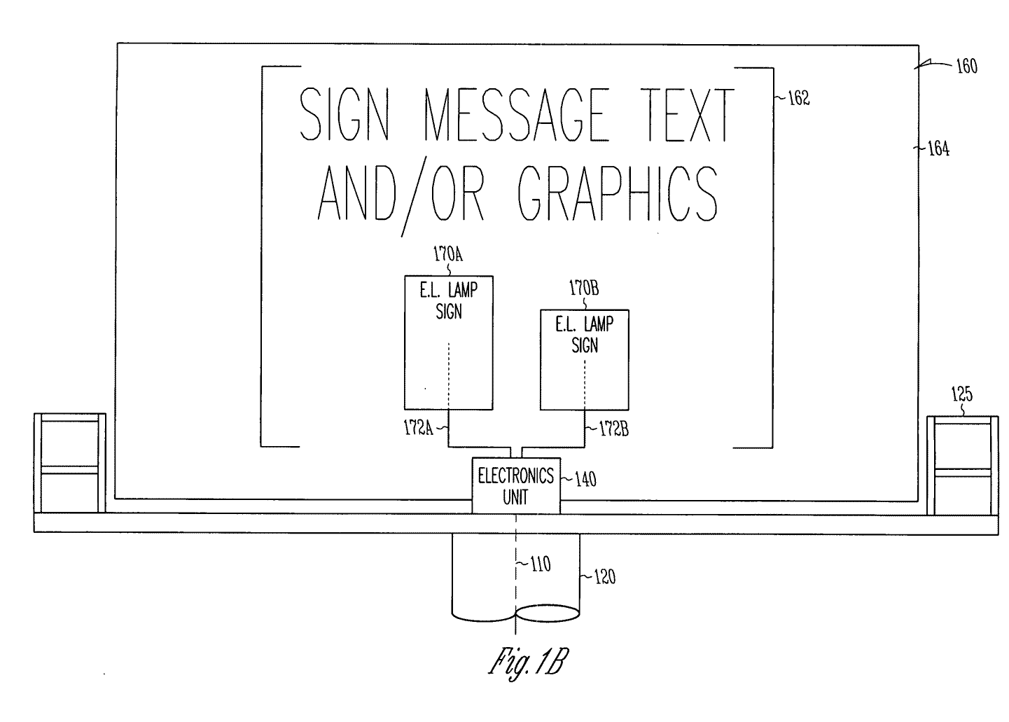

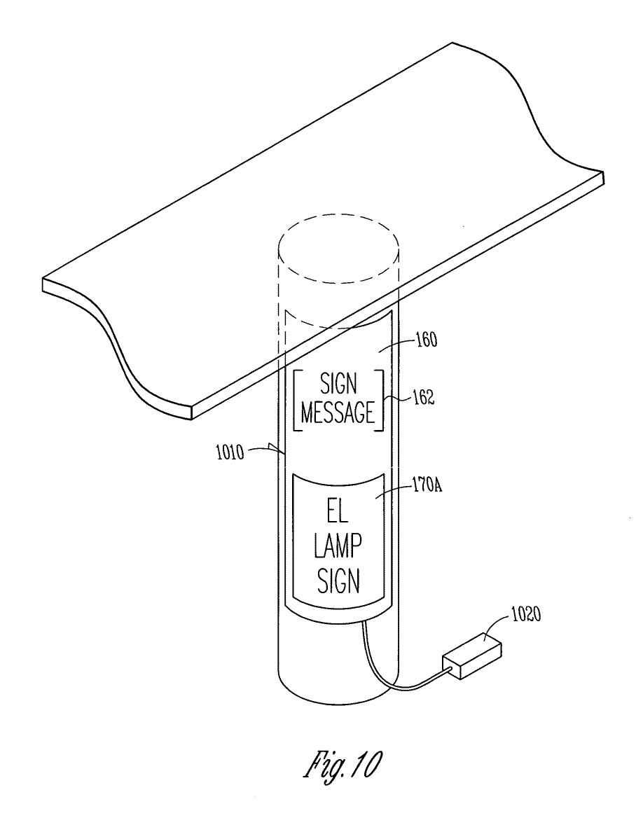

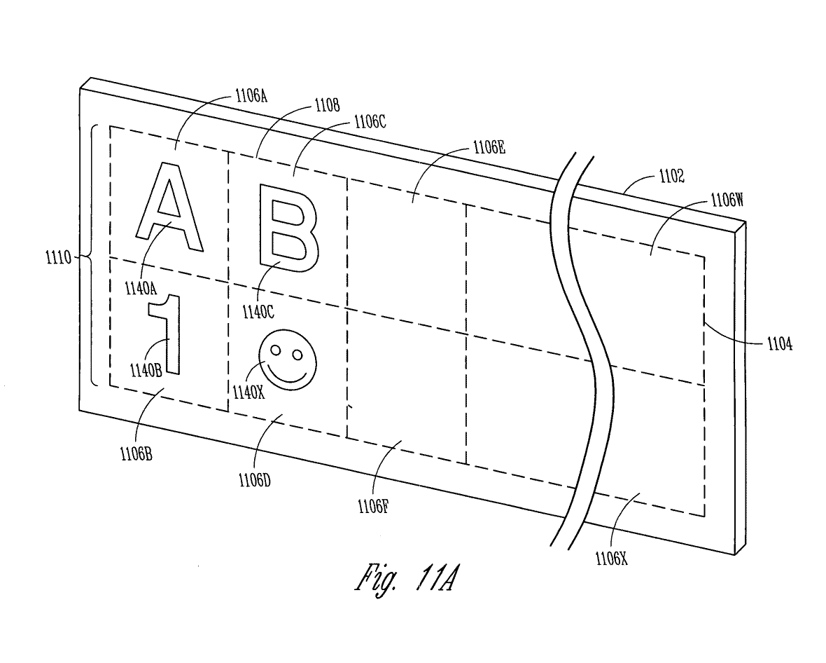

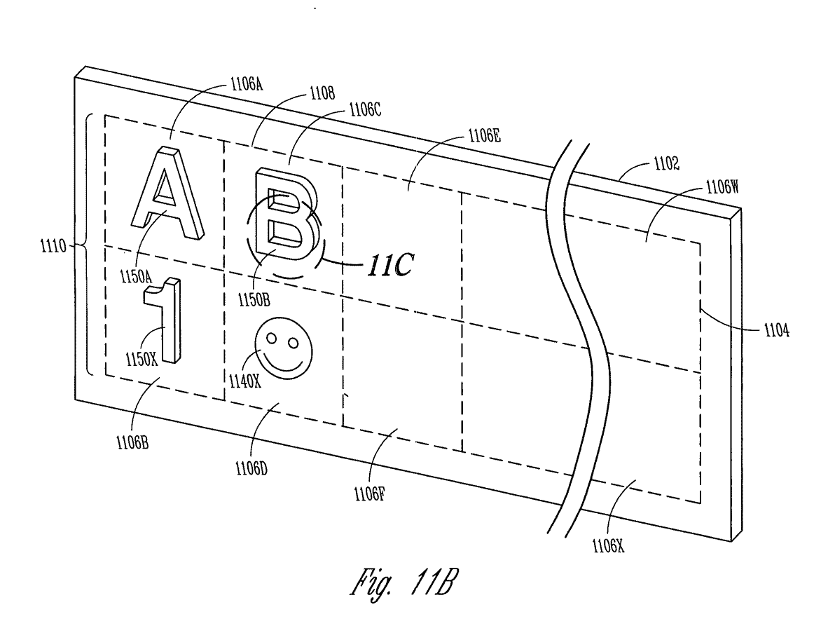

FIGS. 1-10 describe some examples of signs using EL technology. The description of modular signs begins with the discussion relating to FIG. 11.

Referring now to FIGS. 1A and 1B, there is illustrated a first example embodiment of a billboard system 100 and method for installing and using the same. A billboard support structure 120, in one embodiment, includes, in this embodiment, two sign frames 130 supported on the support structure 120. Structure 120 may include one or more vertical support members, such as columns or a support frame. A catwalk 125, to be used by sign installation personnel, may also be provided on the support structure 120.

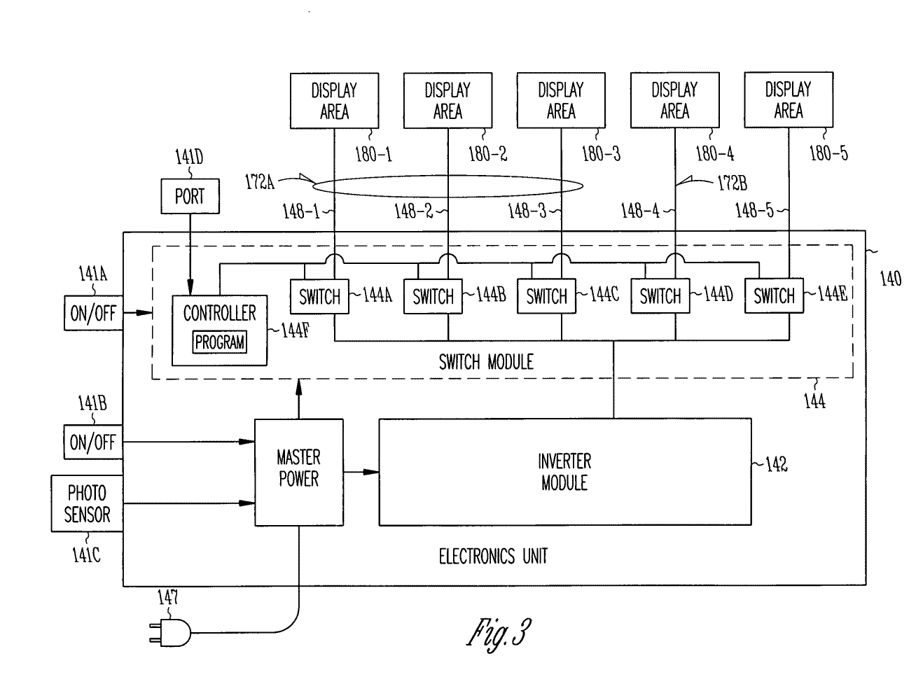

A sign frame 130 supports an EL-illuminated billboard 160 which may be mounted on the sign frame 130. In one embodiment, the EL-illuminated sign 160 includes sign indicia 162 printed or otherwise carried on a vinyl substrate 164 (for example, a vinyl sheet or panel) that is stretched on the frame 130, for example from the edges 166 of the sign 160. In one example embodiment, two EL lamp signs 170A and 170B, collectively or individually referred to sometimes as signs 170, are attached to the vinyl substrate 164. Each of signs 170A and 170B is connected to an electronics unit 140 through a respective wiring harness or bundle 172A and 172B. A source of electrical power 110 is used to provide power to an electronics unit 140. As illustrated in FIG. 3, electronics unit 140 includes an inverter module 142 and a switch module 144.

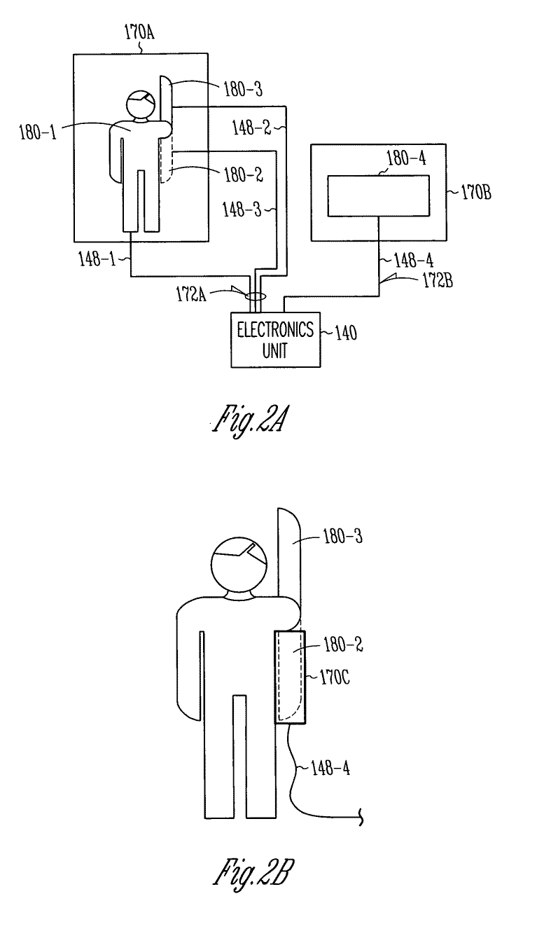

As illustrated in FIG. 2A, in one example embodiment, one of the signs 170A is a character (180-1, 180-2, 180-3) and one of the signs 170B is a smaller logo 182. Sign 170A may include three separate EL illuminated areas and circuits for providing power thereto. A first area 180-1 depicts the body of the character and one arm (left from viewing perspective); a second area depicts an arm 180-2 of the character 180 in a down position; and a third area depicts an arm 180-3 of the character 180 in an up position. A fourth display area 180-4 on sign 170B may also be illuminated. Each area 180-1, 180-2, 180-3 and 180-4 is supplied with a source of power independent of the other, for example through respective circuits 148-1, 148-2, 148-3 and 148-4, allowing the areas to be illuminated independently of one another. This independent illumination may be used to create an animation effect.

According to still another example embodiment illustrated in FIG. 2B, a polarizing panel 170C may be attached to the billboard directly over the arm area 180-2. The panel is electrically activated to pass or block light and may be selectively turned on or off, for example by switch module 144, and in particular the switch 144E for instance, to either pass or block light. When the light is blocked, the area of the panel appears dark, for example black or gray, and hides the arm area 180-2 beneath it. When light is allowed to pass, the arm below is visible. Panel 170C, in one embodiment, is flexible, and may be constructed in the same manner with electrical strain relief and low tack and high tack adhesive components as illustrated with respect to signs 170A and 170B. Low tack and high tack adhesives include low tack and high tack adhesives defined as such by the 3M® Corporation, which is headquartered in St. Paul, Minn.

As illustrated in FIG. 3, according to one example embodiment, the switch module 144 selectively connects the power from inverter module 142 to the circuits 148-1, 148-2, 148-3, 148-4 and 148-5 through switches 144A through 144E. According to another example embodiment, the switches may be deployed remotely from the electronics unit 140. Switches 144A-144E are in turn controlled by a computer control device or other controller device 144F that may sequentially or simultaneously, in any desired order or combination, activate switches 144A through 144E, for example to provide steady state supply of power to some or all display areas 180 or animation thereof.

In one embodiment, the switching or animation function may be activated or deactivated, for example through a switch input 141A to switch module 144, wherein the switch may be accessible on the outside of the housing 145. Further, the master power to the electronics unit 140 may be turned on or off using a switch 141B that is input to the master power module 143. Master power module 143 may receive line voltage from a plug 147 connected to a source of power, or power to module 143 may be provided from other sources as described further below. Further, when the electronics unit 140 is activated, an electric eye or photosensor 141c provides a control input to the master power module 143 or unit 140, in order to turn the electronics unit 140 on at the onset of darkness and turn it off at the onset of light, for example in the morning. According to another embodiment, the activation or deactivation of the supply of power to the display areas 1801 through 180-5 may be accomplished by other configurations of the electronics unit 140. According to one embodiment, the electric eye 141C may be exposed to ambient light through a port, aperture, or window in the weatherproof housing. According to one example embodiment, the exposure of the photocell should be to direct sunlight when the housing is positioned in the field. Further, the photocell 141C should be positioned to avoid illumination from artificial lights. Such illumination may prevent the photocell from detecting a change from daytime to nighttime.

In one embodiment, the switches may be activated so as to create an animation effect on the display or combination of displays. In another embodiment, each switch may be activated in sequence and left on until all other switches are activated, and leaving all activated for a period of time until all are deactivated. In one animation sequence, the display area 180-1 is continuously illuminated through power supplied through circuit 148-1. Supply of power to the arm areas 180-2 and 180-2 may be alternated, for example every ten (10) seconds, to create the appearance that the arm is moving from the down to the up position and back. Arm motion is thus animated. According to one embodiment, the animation is programmed for a 10 second sequence. Other sequences may be provided by programming the switch module 144 by uploading a new program into the switch module 144, for example using a memory stick or other media that may store a program 144G that may be read into the switch module through a port 141D, for example using a universal serial bus and a corresponding USB connector at the physical interface, which may be adjacent the controller or have a port on the surface of the housing 145. According to another example embodiment, a ground fault switch may be provided in the circuit supplying line voltage to the electronics unit 140, and be adapted to reset automatically, such as in one minute, following a ground fault that trips the switch off.

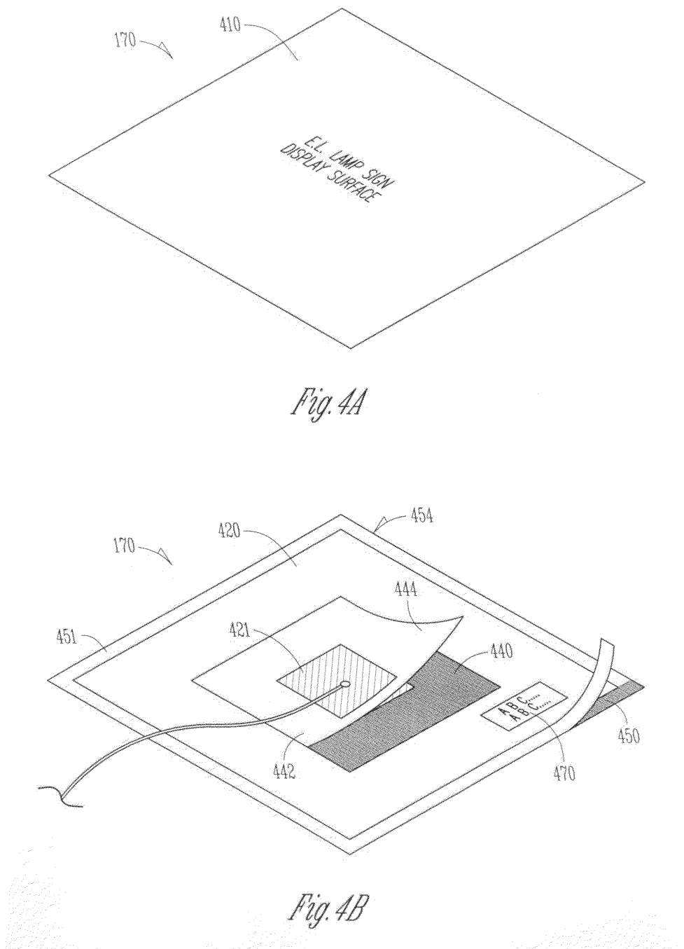

In one example embodiment, illustrated in FIGS. 4A and 4B, each EL lamp sign 170, and particular EL lamp components in the signs, are constructed from flexible materials, such as polymers and/or materials used for flexible printed circuit boards, such that the units 170 may be folded or rolled. A wiring harness 172 (for example 172A or 172B), including wiring for the circuits (such as circuits 148-1, 148-2, 148-3 and 148-4) supplying power to the EL lamp signs, may be connected to the sign 170 in the center of the back of the unit, optionally mechanically secured using a strain relief mechanism 421 in the form of a thicker plastic, rubber or polymer member that is adhered to the back 420 of the EL lamp sign, and supplies power to the respective areas 180-1, 180-2, 180-3 or 180-4. The wiring harness 172 is connected to the electronics unit 140. If the EL lamp sign 170 is attached to the billboard 160 in a position above the electronics unit 140, the wiring harness 172 is run downward under the sign (sandwiched between the sign 170 and the underlying vinyl sign), and if the EL lamp sign 170 is attached in a position below the electronics unit 140, the wiring 172 is run upward to the module 140 under the sign 170. According to still another example embodiment, all wiring from the EL lamp signs should be secured with fasteners or tape such as snaps, clips or colored or clear tape to conceal them to the billboard graphics. These fasteners may be included with the vinyl billboard provided for the sign installation. According to one example embodiment, harness 172 takes the form of a flat cable with multiple conductors arranged side by side along the length of the cable.

According to still another example embodiment, the inverter module 142 and switch module 144 may be provided as an integrated module that may be inserted or installed in the electronics unit 140, so that additional power and switching capability may be added to the unit 140 by installing another such module.

Further, in one embodiment, the electronics unit 140 has a corresponding female connector for each sign wiring harness 172 (which may for example be identified as “A” or “B”). According to one embodiment, the connectors on the electronics unit 140 are designed to fit only the appropriate respective connectors on the wiring harnesses for the respective signs, for example signs 170A and 170B.

In one embodiment, illustrated in FIG. 4B, a low tack “positioning adhesive” 440 is located in the middle 442 of the back of the EL lamp sign 170, around the strain relief member 421, and is covered by a release paper 444 that may be pulled off when the adhesive is to be used to position the sign. The low tack adhesive is adapted to allow the sign to be stuck to the vinyl sign 160 but still be moved to make adjustments to its position, for example by sliding it along the surface of the sign 160 or rotating it to move it up or down or side to side or about its center, or be pulled off and reapplied. High tack adhesive 450 is also included on the back of the EL lamp sign and is covered with release paper 451. According to one embodiment, the high tack adhesive is disposed around the perimeter 454 of the sign. Once the sign is properly positioned using the low tack adhesive, the release paper on the high tack adhesive is removed and the sign 170 is adhered to the billboard using the high tack adhesive. In one embodiment, vinyl billboard 160 may be prepared for installation of an EL lamp sign 170 using a cleaner to prepare the vinyl to adhere to the EL lamp signs 170. According to one embodiment, a solution of 50% water and 50% isopropyl alcohol may be used, but any other workable solution may be substituted.

Further, according to one example embodiment, each EL billboard 170 will have a sticker 470 on the back that will indicate by market and by location where that sign should be posted, and for example may be assigned a number that correlates to a specific billboard location.

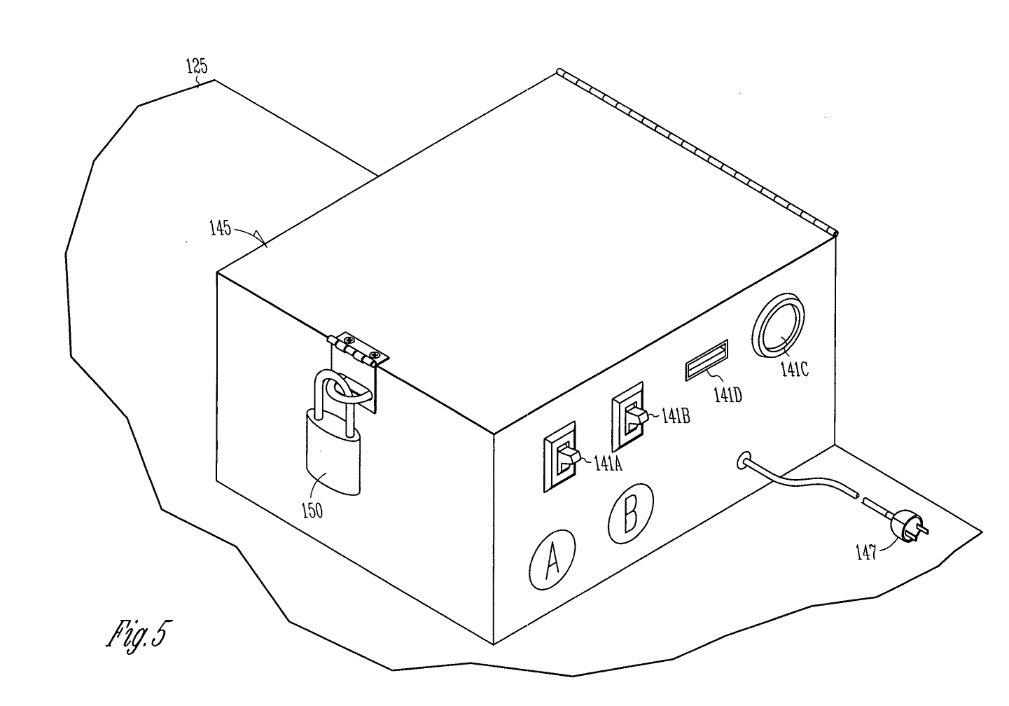

As illustrated in FIG. 5, in one embodiment, the electronics unit 140 is mounted near the frame 130 inside a housing 145. Housing 145 may be secured to the billboard support structure 120, such as the catwalk 125 behind or in front of the billboard, or any other structure near the billboard such as on a rooftop. According to one embodiment, housing 145 is a weather-proof box, and includes fire, moisture, and other protections designed into the housing 145. If the housing 145 is located in an unsecured area, a pad lock 150 may be required to secure the housing to ensure the electronics unit 140 is protected from tampering.

The power source 110 may be provided proximate the frame system 130 to provide power to the electronics unit 140. In one embodiment, the power source 110 is line voltage, for example 115/120V AC power in the United States, or higher or lower voltages in other countries, with a ground (for example three prongs). According to another embodiment, the power source 110 may be a DC power source 110 such as a battery, for example an automobile battery voltage such as 12V DC, or any other DC voltage. According to another embodiment, the battery may be recharged using solar power, such as may be provided by a solar power device positioned to collect solar energy and convert it to a charging current that may be applied to the battery. According to one embodiment, the electronic modules 140 is mounted under or on the bottom of the billboard frame 130, and in another embodiment may be mounted over or on top of the billboard frame 130 (more likely for wall billboards where the electronics may be mounted on a roof above the sign). According to one example embodiment, there may be two different sizes of the EL electronics units 140, one for EL lamp signs that are 20 feet by 20 feet or 25 feet by 25 feet in dimension, and one for signs of smaller dimension.

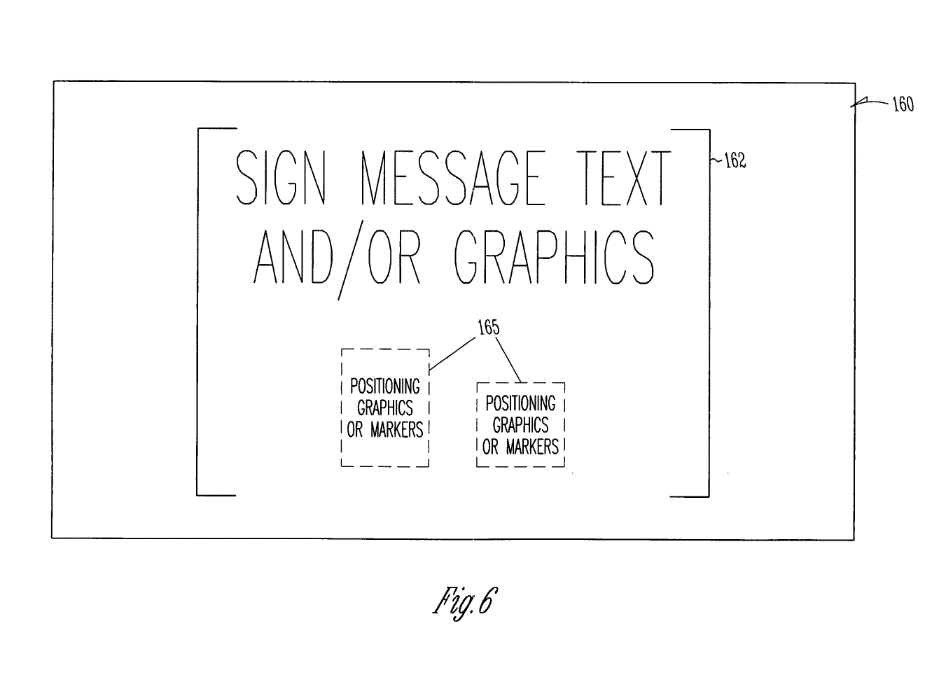

According to one embodiment, the EL lamp signs 170 may be attached before the vinyl billboard 160 is attached to the frame 130. According to one example embodiment, as illustrated in FIG. 6, the graphics 162 include graphics and/or alignment markers 165 on the sign that show where the EL lamp signs 170 are to be positioned on the sign 160, and that are covered by the signs 170 when applied. The graphics and/or markers may serve as a guide for where the EL lamp signs 170 will be set.

According to one example embodiment shown in FIG. 7, one or more, for example up to five (5) EL lamp signs 170, may be stored and transported in a cylindrically shaped container (tube) 700. In FIG. 7, lamp signs 170A and 170B are shown rolled up in tube 700. According to one example embodiment, the tube 700 may measure approximately 13 feet long and up to 24 inches diameter. At least one of the signs 170 in this example embodiment has an EL lamp size up to approximately 12′×12′. In another embodiment, the signs may be as described above, each EL lamp sign 170 is fabricated from flexible material so that it may be rolled up for storage in a container 700 with the graphics facing to the outside of the roll to minimize the risk of damage from rolling the signs.

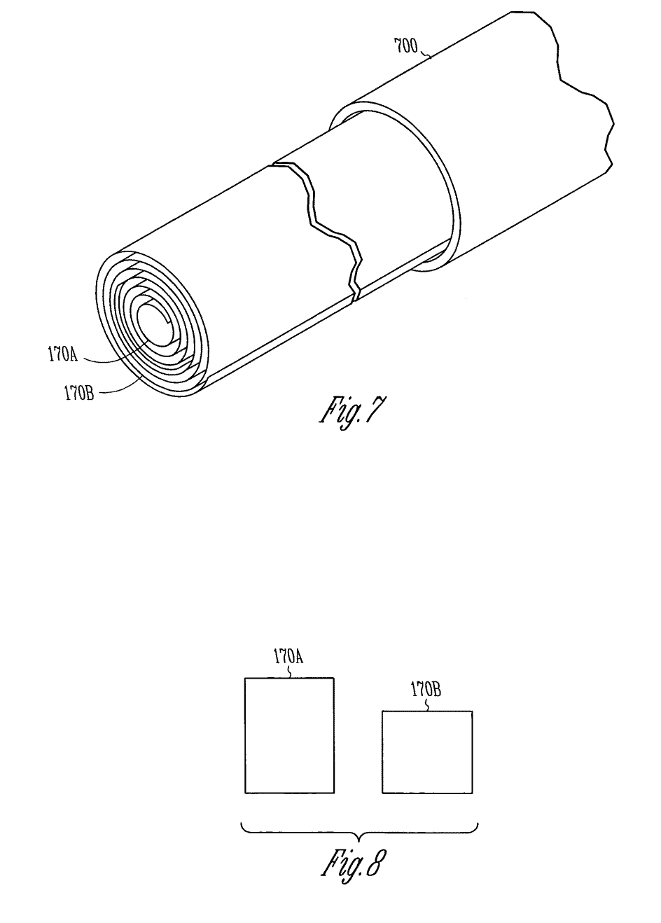

According to one embodiment, the EL lamp signs 170 may be combined into groups or sets that are used in combination for a particular advertising application. For example, a set may comprise the two EL lamp signs 170A and 170B, for example, as illustrated in FIG. 8. As illustrated in FIG. 8, one of the signs A is a character and one of the signs B is a smaller logo. According to one embodiment, two of the packages may be stored and transported in a container 700.

According to one example embodiment, one or more electronic units 140 and signs 170 are shipped to a desired destination, with the signs packaged in the container 700. Once the container 700 is received, each sign 170 may be unpacked and inspected to ensure that it was not damaged in transit, and to confirm that the signs 170 match the market and location(s) they have been shipped to or are intended for. According to one example embodiment, each EL lamp sign 170 is unrolled on a flat surface (preferably indoors in a warm area, for example approximately 60-80 degree Fahrenheit ambient) and allowed to relax for a period of time, for example at least about 30 minutes or more. Preferably but not by way of limitation, each sign 170 should be placed face down—that is the front of the sign is facing the flat surface. According to one example embodiment, the wiring connections may be connected to the electronics unit 140 to ensure that the signs work properly prior to installing.

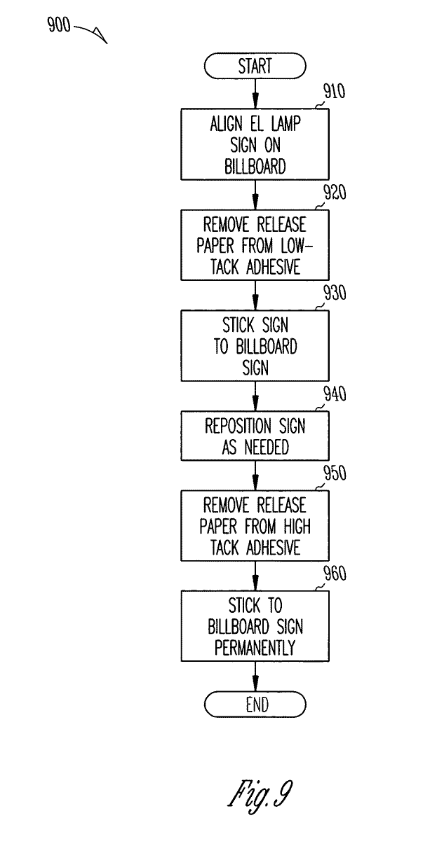

Thus, according to one example embodiment of a method 900 illustrated in FIG. 9 according to the inventive subject matter, an EL lamp sign 170 is first aligned 910 on the sign 160. Once the EL lamp sign is aligned correctly, the release paper is pulled off and removed 920, exposing the low tack positioning adhesive 440 located in the middle of the back of the sign. The EL lamp sign 170 is then stuck 930 to the sign 160 and, as necessary only, moved or adjusted 940 until the positioning is acceptable. The high tack adhesive 440 is then exposed by removing 950 the release paper and the sign 170 is then pressed 960 onto the sign 160 to adhere it on the sign 160.

According to one example embodiment, the method provides for adhering the EL lamp signs 170 to the vinyl billboard 160 using the low tack adhesive before it is mounted on the billboard frame. The sign 160 with the EL lamp sign 170 may then be rolled up for transport to the billboard frame, preferably, according to one embodiment, with the graphics on the sign 170 facing out. After the vinyl billboard is installed on the billboard and is stretched tight, the release paper covering the high tack adhesive is removed and the sign is further adhered to the sign 160 using the high tack adhesive. Thus, according to one embodiment, the low tack adhesive is formulated so that the EL lamp sign 170 stays adhered sufficiently to the sign vinyl while and when it is stretched so that the sign 170 does not fall off prior to it being permanently adhered to the sign using the high tack adhesive. As noted above, the high tack adhesive is disposed around the perimeter of the sign. Once adhered with the high tack adhesive, the position of the EL lamp sign 170 is substantially or completely fixed in position.

According to one example embodiment, the electronics unit 140 may be owned by a first entity different than the owner or operator of the billboard on which it is deployed. The electronics unit 140 may be installed at a billboard location, for example on the frame 130 as described above, and remain at the designated site for example to be used with successively different signs 160 and EL lamp signs 170.

In another example embodiment, the EL lamp signs 170 may be mounted on other sign surfaces or media, such as paper posters glued to wood, metal, mesh or plastic billboard backing. Or, the posters may be made of any other material or supported using other billboard systems.

According to still another example embodiment illustrated in FIG. 10, a sign 160 with at least one flexible EL lamp sign, such as sign 170A, is wrapped around a circular column 1010 or other curved surface or surface with one or more corners, and powered by a power unit 1020 that includes at least a battery (which may be rechargeable), an inverter module and, optionally, a switch module. In another embodiment, the sign 160 may be omitted and only the EL lamp sign wrapped or mounted on the column. Power unit 1020 may be adhered or otherwise fastened to the column 1010, or may be positioned on the floor or ground adjacent the column 1010. In another embodiment, the power unit 1020 may be provided remotely from the column with low power voltage to power the lamp sign running to the column on the floor, overhead or along walls.

According to one example embodiment, the signs 170 include planar EL lamps that may be illuminated with white or light colored EL lamp elements. According to one example embodiment, the white or color may be produced by the EL light produced directly by the fluorescing elements in the lamps or by the light produced by the lamp filtered through a colored transparent overlay, for example, but not limited to, as shown in U.S. Pat. No. 6,769,138 to Golle, incorporated herein by reference. These white or colored lamps are used alone or in combination with colored transparent overlay that may function as a lens and which may be illuminate with the EL lamp element to produce a color the same or different from the color of the colored overlay and/or the color of the EL luminescence. In one embodiment, the EL lamps are formed in the shape of the alphanumeric characters of sign indicia. Such lamps may be formed for example using a silk-screening process, or any other process now known or later discovered. In another embodiment, the lamps may be covered with a mask that exposes only the alphanumeric characters of sign indicia, such that the entire surface area of the lamps illuminate with EL light but only the area exposed the mask is visible. Further, in another embodiment, the EL lamp signs may be linear and/or tubular, for example in the form of EL illuminated “rope” that may have one or more segments each independently controlled for illumination, for example so as to allow the segments to be consecutively illuminated to create the appearance of movement, in any manner imaginable.

FIGS. 11A-B illustrate a billboard that changes in appearance over a number of post dates, according to some embodiments. The billboard 1102 can provide a changing appearance over time through modification of the billboard 1102 by addition or subtraction of individually affixable EL modules 1150A-X to or from the billboard. The appearance of the billboard 1102 changes because EL modules 1150A-X are added to or subtracted from the portion of the billboard 1102 intended to be viewed.

As used herein, an EL module includes one or more EL lamps attached to a module frame. EL lamps can include, but are not limited to, the following materials: powder zinc sulfide doped with copper or silver; thin film zinc sulfide doped with manganese; natural blue diamond (e.g., diamond with boron as a dopant); III-V semiconductors such as InP, GaAs, and GaN; and inorganic semiconductors, such as [Ru(2,2′-bipyridine)₃]²+(PF₆—)₂.

The EL module generally has a smaller area to be viewed than that of the billboard to which it attaches. Some EL modules are sized so that a single worker can carry them. For examples, some EL modules have a width that is less than the average arm span of an adult human. Some are weighted less than or equal to a regulated weight suitable for lifting by an average adult.

A module frame can include, but is not limited to, one or more of: a frame or backing to resist ripping of the EL lamp, such as by providing a higher tensile strength than the EL lamp; a frame or backing to provide rigidity to the EL lamp so that it is stiffer than the EL lamp alone; a frame or backing to provide increased stiffness over the EL lamp for the EL module so that the EL module can be handled by a worker; and/or a mask to mask the EL to limit the amount of light that emanates from the EL lamp by occluding portions of an illuminated surface of the EL lamp.

The EL module can also include one or more connectors for connection to a circuit to illuminate the EL lamp; optional inverter modules to convert power to power suitable for use by the EL lamp; and optional switch modules to receive illumination commands and to communicate with power conversion electronics to illuminate the EL lamp. The inverter modules and the switch modules may be integrated into an electronics unit that is part of the EL module, as is discussed in relation to FIG. 3.

An EL module can be constructed in a fashion similar to the billboard constructions discussed above in relation to FIGS. 1-10. In various embodiments, an EL lamp is sealed into an EL module. The seal can be provided by lamination or pressure sensitive adhesives. Various types of seals are contemplated, including, but not limited to, moisture resistance, weather resistance and water-proofing. Various examples of weather or water-proof configurations are provided in the paragraph starting on column 2, line 61 of U.S. Pat. No. 7,316,491 to Golle, et al., filed Oct. 25, 2006, which is commonly assigned and incorporated herewith in its entirety.

The appearance of the billboard changes over time. As an EL module billboard evolves over time, the amount of EL lighting that covers the portion of the billboard which is intended to be viewed changes. More or less EL is displayed as part of the billboard over time. The billboard in a non-EL illuminated state can also change over time. This change is because one or more EL modules can cover billboard indicia with EL module graphics that differ from the billboard indicia.

The term “indicia” is used herein for simplicity in explanation, but expressions of indicia can also relate to a single indicium. The term “graphics” is used herein for simplicity in explanation, but expressions of graphics can also relate to a single graphic. Indicia include, but are not limited to, letters, numbers, graphics or other visual cues. The term “sign indicia” refers to visible cues on a billboard sign that are intended to be viewed by members of a target audience. Various sign indicia may be provided, such as pictures of automobiles, pictures of persons, letters, etc., so that the billboard serves to advertise a message.

Time periods for display of signs include multiple post dates. A post date is a date on which a worker is to perform a change to a sign and encompasses the time to complete the changes to a sign. For example, the sign is completely posted or installed on a single post date that may span several hours or several days. Complete installation means that the visual appearance of the sign is complete as it is intended to be viewed by the audience. In some embodiments, several post dates are used over time to evolve the appearance of a sign. This provides a varying and entertaining sign for people to view. The sign is considered interesting for a longer period of time because it evolves from a sign that does not glow to one that has a varying level of EL illumination, such variation being associated with added or subtracted EL modules. EL modules can be added singularly or in groups on one or more post dates.

In various embodiments, the sign provides an evolving appearance at a lower cost than an LED billboard. Additionally, the sign has the benefit of looking like a sign that is not electronic and that is not pixilated. Some advertisers prefer non-pixilated signage to communicate their message, and signs that use EL modules more closely resemble these signs. For example, the present subject matter can provide a sign that more closely resembles older marquees that includes hand-placed letters. The present subject matter can provide a traditional looking marquee that is backlit.

In some embodiments, on a first post date, the billboard 1102 is adorned with sign indicia 1140A-X, to provide an advertisement, for example. On this first post date, no EL modules or EL lamps are affixed to the billboard 1102. At a further post date, some or all of the sign indicia 1140A-X are covered up or masked with individually affixable EL modules 1150A-X. EL lamps of the EL modules are illuminated and provide EL module graphics that glow. These EL modules change the appearance of the sign indicia to EL module graphics in a modular fashion. The EL module graphics can either mimic the sign indicia they cover, or they can provide EL module graphics that look different from the sign indicia originally provided. The EL module graphics include letters “A” and “B” and the number “1” as illustrated in FIG. 11B. These graphics are visual duplicates of the sign indicia that they cover. The covered sign indicia are illustrated in FIG. 11A.

An EL module including EL module graphics that mimics original sign indicia can be installed and in many cases the viewing public will not be able to tell that it is installed until nightfall, when the EL lighting of the EL module is illuminated. In this manner, a sign that viewers had come to understand was not illuminated can provide a surprise in that it is presently illuminated. Advertisers can use this phenomenon in different ways to entertain viewers. Further, the present subject matter allows advertisers to provide interesting signs over a longer period of time, which in some cases allows them to regulate cash flow and purchase multiple, less-expensive postings associated with individual post dates rather than one expensive posting associated with a single post date.

By using multiple post dates, workers may be coordinated to update signs in multiple remote locations in unison (within a 24 hour period of one another, for example). Multiple remote locations can include multiple sign locations, such as in different portions of a city, or multiple towns or cities. This type of coordinated effort provides for a far-reaching advertising campaign that can help facilitate audience reactions.

For example, a 1-10 counting progression is presented to viewers over several post dates by affixing and illuminating EL modules incrementally. On a first post date and among a plurality of billboards, an EL module including EL module graphics representing the number “1” with an EL lamp is affixed an illuminated. On a following post date, among the plurality of billboards, a second EL module including EL module graphics representing the number “2” is affixed and illuminated, and so on.

An EL electronics unit (e.g., the electronics unit of FIG. 3) can be part of the EL modules, or it can be provided by the billboard 1102 and EL modules can be connected to it as they are added. After a plurality of EL modules is in place, one or more of the plurality of EL modules can be animated. Animating includes illuminating one or more EL lamps of an EL module or assembly of EL modules in a sequence. Animations include staggering the start or stop times of illumination periods by specified time increments. Animation sequences can be controlled by an animation program. An animation program is part of a software program installed in an electronics unit. This software program includes instructions that can be used by one or more controller units to control switch modules. The animation program may be stored in the controller device. This software can be stored using durable memory devices, such as application specific integrated circuits, read only memories, or hard disks. Software can also be provided using removable media such as compact discs or flash drives.

To add EL modules to the billboard 1102, workers need to know where the EL modules are to be placed. The billboard 1102 may include alignment markers to assist in aligning EL modules 1150A-X with the billboard 1102. The term “alignment markers” refers to visible cues on a sign that are used for aligning an EL module to a sign. In some instances, alignment markers generally are not visible to the target audience. The alignment markers can include printing (e.g., cross hairs representing corners to border a rectangular EL module), indentations or an array of fasteners such as pegs or rivet eyes. Two basic alignment markers schemes are used: one that provides regular repeating coordinates, and one that provides alignment markers irregularly.

A first alignment scheme provides alignment markers according to regular repeating coordinates to be used for alignment. The coordinates map the billboard using regular distance intervals. In some embodiments, the billboard 1102 includes a graph that is superimposed on the billboard 1102. The graph is comprised of alignment markers that include lines that include coloring and line width that provide contrast so that the line can be seen when standing close to the billboard 1102, e.g., within an arm's reach of an adult, but which are not colored or heavy enough to be seen by the audience targeted for advertising (for example, drivers or pedestrians).

The coordinate system 1104 is defined by a plurality of alignment markers that define regularly repeating rectangular zones 1106A-X aligned so that they define a grid 1110. The grid includes lines 1108 that define zone boundaries. Lines 1108 can include, but are not limited to, linear printing and indenting of the billboard surface. Although the grid 1110 is illustrated having two rows (e.g., 1106A is in a first row, and 1106B is in a second row), embodiments having more than two rows, or less than two rows, are possible. One or more columns are also defined by the grid in various embodiments. The subject matter is not limited to rectangular (i.e., Cartesian type) coordinates, and other coordinates systems are possible, such as radial coordinate systems. A radial coordinate system would provide a center point and axes intersecting with that center point, and a coordinate could be determined by providing a distance from the center point and an angle to at least one of the axes.

The second alignment scheme uses a plurality of alignment markers to indicate to workers where EL modules are to be placed. The alignment markers do not necessarily repeat at regular intervals. For example, one or more of the EL lamps of FIGS. 2A and 2B could be attached to a billboard as parts of EL modules and aligned with alignment markers printed on the billboard. The EL modules could be aligned by fitting inside outlines, or they could be aligned to two or more dots, one or more cross hairs, or other alignment markers. Hence, a billboard without any EL modules installed could be made to operate as the billboard of FIGS. 2A and 2B through the addition of EL modules that are aligned to alignment markers. In some instances, the sign indicia 1140A-X are used for alignment, and alignment markers are not included. For example, EL module 1150A can be aligned to sign indicia 1140A. In additional embodiments, an EL module is rectangular and is outlined by lines 1108.

Alignment markers are used to coordinate placement of EL modules. Alignment markers can include labels 1109A, . . . , 1109C used for indexing. Such labels can include letters, numbers, colored shapes such as colored dots, and the like. Workers can match a label on an EL module to a label on a sign so that they understand that they are installing the EL module in the correct place. In some examples, the billboard is divided into zones and each of the EL modules could fit into any of the zones. In these examples, labels are used to instruct workers as to the zone to which an EL module should be aligned to.

FIG. 11C illustrates alignment pointers, according to some embodiments. Alignment pointers 1107A, . . . , 1107C can be included on the EL modules. These markings, graphics or features (e.g., apertures) can be disposed in the EL module so that they are difficult to view at the distance the intended audience is to view the EL module once it has been installed. An alignment pointer can include an arrow or a pin hole that is for alignment to the alignment markers printed on the billboard 1102. In some examples, the EL module includes eyelets such as rivets and these provide alignment pointers 1107A, . . . , 1107C. Screws can be driven through the eyelets. The target for the screw is an alignment marker on the billboard 1102. In some examples, the alignment marker indicates where a hook is to be affixed, and an eyelet of the EL module is fastened to the hook. These fastening mechanisms are not exhaustive of exclusive of the present subject matter, and further fasteners can be used.

In various embodiments, the coordinate system 1104 is easily visible at arm's length, and is less visible beyond arms length. Embodiments which include a coordinate system visible only at a distance of less than about 5 ft. from the sign, less than 10 ft. from the sign, and less than 20 ft. from the sign are possible. Embodiments in which the coordinate system is visible only at a distance less than a government regulated distance between a roadway and a billboard are also contemplated. Some examples include a sign such as kiosk that includes a coordinate system visible only at a distance less than about 1 ft.

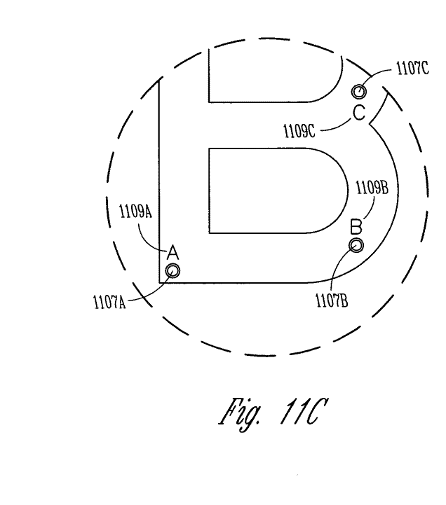

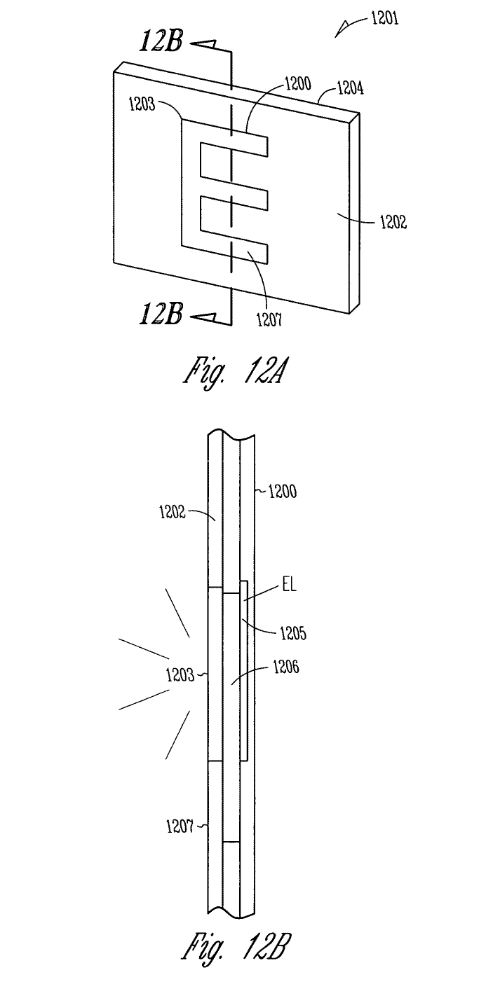

FIG. 12A illustrates an isometric view of a portion of a billboard 1201. FIG. 12B illustrates a side cross section view of the billboard 1201, including an EL module 1200 that includes an EL lamp 1205 to shine through sign indicia 1203 of a billboard film 1202, according to some embodiments. Sign indicia 1203 can include an opening, or translucent material. The billboard film is a piece or sheet of vinyl.

In some embodiments, the billboard 1201 includes a backing 1204 to which a billboard film 1202 is attached, via adhesive or other fasteners. The attachment of the billboard film 1202 may be via traditional paper hanging methods. The film 1202 can be paper or polymeric.

In some examples, the film is continuous. Continuous indicates that the entire billboard is comprised of a single sheet of plastic that may include other advertising printing. For example, in some examples, a one-piece vinyl sign may be fixed to a billboard backing 1204. Some embodiments may stretch the vinyl to fit so that it doesn't flap in the wind to the extent that it is damaged. The vinyl may be stretched over a frame or may be tied to a frame so that it is taught.

In various embodiments, the billboard film 1202 is transparent or semi-transparent along at least a portion of the film defined by sign indicia 1203. The backing portion 1204 may include an opening 1206. The film 1202 may be aligned with the backing 1204 such that the sign indicia 1203 are aligned with the opening 1206. In some cases they are coextensive, but the present subject matter is not so limited. The EL module 1200 may be aligned to the billboard 1201 so that the EL element 1205 shines through the opening 1206 and the sign indicia 1203. In some embodiments, alignment pointers 1209, as illustrated in FIG. 12C, are used to align the EL module 1200 to the opening 1206. In some instances, the EL element 1205 is sized so that it is substantially coextensive with sign indicia 1203. In further embodiments, the EL element is larger and shines through sign indicia.

The opening 1206 can already exist on a post date in which the film 1202 is applied, or alternatively, it can be created anew, such as by cutting the backing 1204, during a later post date that coincides with the addition of the EL module 1200. In some embodiments, instead of defining a transparent or semi-transparent portion of the film 1202, the sign indicia 1203 define an opening in the film 1202. In some of these embodiments, a film 1202 and a backing 1204 are cut together to create the opening 1206 and the sign indicia 1203. Such cuts could follow a marking scheme printed on the film.

In various embodiments, there is no opening 1206, and the EL element may be sandwiched between the backing 1204 and the film 1202 and may be in alignment with the sign indicia 1203 to shine through the sign indicia 1203. In some embodiments, EL is applied to the back of a film and then the film is hung onto a frame. In some of these embodiments, the film is stretched over the frame.

In some embodiments, the sign indicia 1203 are made to resemble first sign indicia during daylight, and to resemble further sign indicia during night hours. For example, the EL module 1200 may be applied to the billboard backing 1204 so as to display the sign indicia “E” during the daylight and the sign indicia “F” during the nighttime hours. In various embodiments, this effect is caused by an opaque portion 1207 of an EL module restricting passage of light from the EL lamp through the film 1202. Accordingly, at night, the sign indicium 1203 resembles the letter “F” while the EL sign is illuminated. Such a system allows for a dynamic sign display using EL elements. EL module graphics that is exactly or approximately a visual duplicate of sign indicia may be used.

FIG. 13 illustrates a side cross section view of a billboard including an EL lamp shining through sign indicia and affixed to the billboard, according to some embodiments. An EL module 1300 includes an EL lamp 1305 shining through a mask 1304. A frame 1302 supports the EL lamp 1305. Masked EL 1305 and its module frame 1306 are discussed above. The EL module 1300 is attached to a billboard 1306. Various embodiments fasten the EL module 1300 to the billboard 1306 using one or more fasteners 1308A-X which can include, but are not limited to, screws, nails, hook and loop fasteners (e.g., Velcro® fasteners), sewing, staples and adhesives.

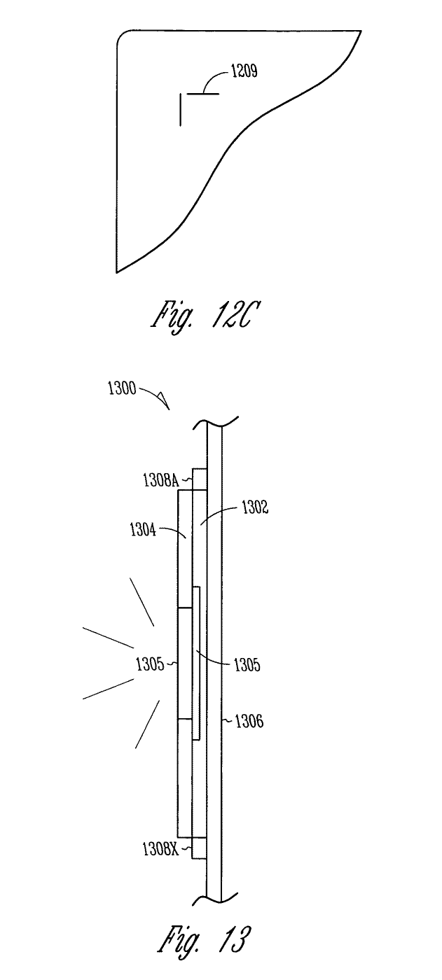

FIG. 14 illustrates a side cross section of a billboard including an EL lamp affixed to the billboard, according to some embodiments. An EL module 1400 includes an EL element 1402 and a module frame 1403 posted onto a billboard 1404. Various embodiments include fastening the EL module 1400 to the sign 1404 using fasteners 1406. Fasteners can be any of those disclosed herein.

In various embodiments, sign indicia are disposed along an opaque portion 1407 of the billboard 1404 and at least one EL module 1400 masks the opaque portion 1407. The EL lamp 1402 shines away from a surface 1409 of the billboard 1404 on which the sign indicia are disposed.

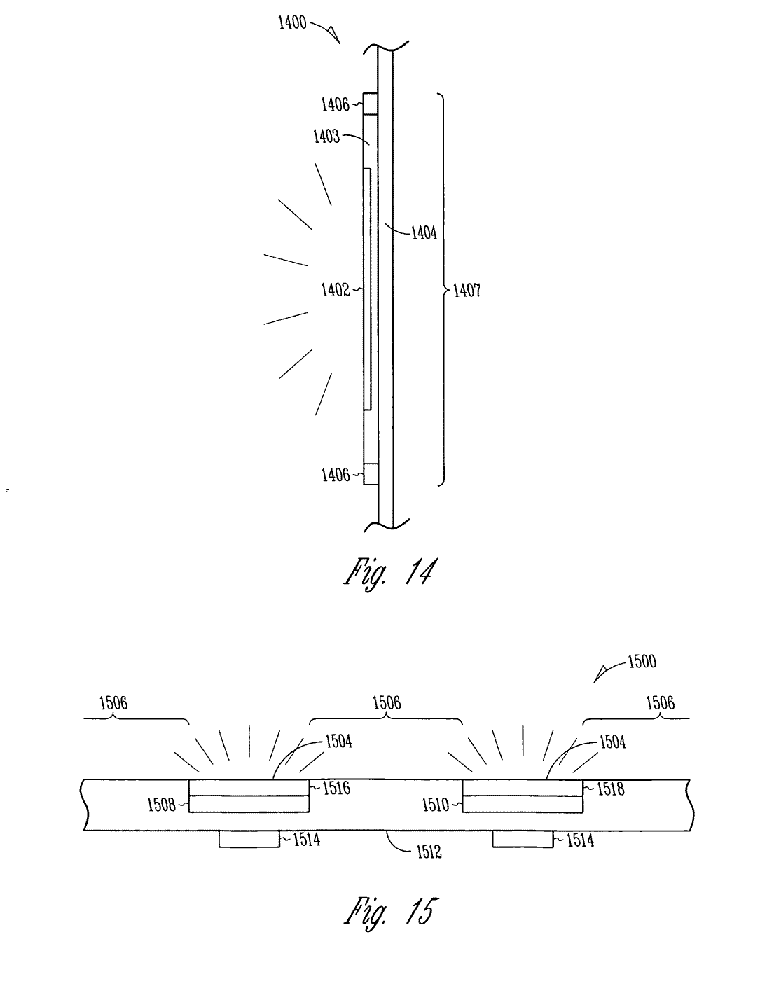

FIG. 15 illustrates a cross section of a billboard 1500, according to some embodiments. A substrate 1502 is attached the billboard 1500 that has a back 1512 and that is supported by posts 1514. The substrate 1502 can be at least partially formed of vinyl in some embodiments. Portions 1506 of the substrate 1502 are opaque. Additional portions 1504 of the substrate are at translucent. Adhered to the substrate 1502 are EL lamps 1508 and 1510. These are illuminated in parallel in some embodiments, and in some embodiments each of them are individually switched on or off so that they are illuminated according to a sequence. The EL lamps 1508 and 1510 are attached to the substrate 1502 using adhesives 1516, 1518 in some embodiments. In various embodiments, these adhesives are transparent.

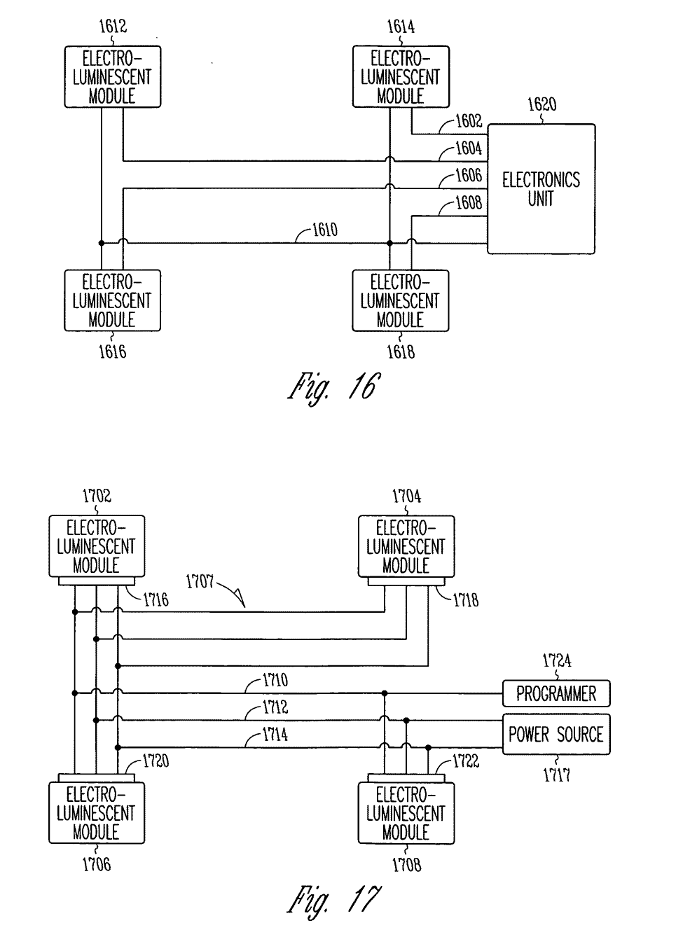

The present subject matter illuminates one or more of the plurality of EL lamps, in various embodiments. FIGS. 16-17 illustrate a plurality of EL lamps, according to some embodiments. Illumination can occur according to one or more processes, such as always-on or animation processes.

The embodiment illustrated in FIG. 16 includes power circuits 1602, 1604, 1606 and 1608. Various embodiments include a ground circuit 1610. A single ground circuit is provided to simplify the wiring harness used in the present embodiment. Alternate designs allow for individual ground connections that use additional wiring. The electronics unit 1620 provides an alternating current voltage in various embodiments, as is used by various EL lamps. The electronics unit 1620 can include the electronics unit of FIG. 3. The electronics unit 1620 may include one or more inverter EL modules to be powered by energy from a first external power source, such as a municipal external power source, to produce a second form of energy, such as a voltage suitable for use by an EL lamp. Each of the power circuits 1602, 1604, 1606 and 1608 lead to an AC voltage source. The power circuits 1602, 1604, 1606 and 1608 can be activated all at once or individually according to an animation process. Various embodiments include an animation circuit (e.g., the animation circuit of FIG. 3) to independently power the EL modules 1612, 1614, 1616 and 1618 according to a timing signal.

FIG. 17 illustrates a plurality of EL modules 1702, 1704, 1706 and 1708, according to some embodiments. The system includes a communications circuit 1710, a power circuit 1712 and a ground circuit 1714. In various embodiments, the first 1712 and second 1714 power circuits provide power to electronics units 1716, 1718, 1720 and 1722. The communications circuit 1710 is to carry animation information from a programmer 1724 to a control device of one or more of the electronics units 1716, 1718, 1720 and 1722. The communications circuit 1710 can optionally extend from electronics unit 1718 to programmer 1724 in ringed network embodiments.

The electronic units 1716, 1718, 1720 and 1722 may comprise the components of the electronics unit of FIG. 3. In various embodiments, each of the electronics unit is part of an EL module 1702, 1704, 1706 and 1708. The electronics units 1716, 1718, 1720 and 1722 may each include power inverters.

In some embodiments, the electronics units 1716, 1718, 1720 and 1722 may be individually programmed. The programs can be provided to controller devices of the electronics units via ports in the electronics units that are coupled to the controller devices. The controller devices can be programmed via a USB or a memory stick and the like.

In further embodiments, the electronics units 1716, 1718, 1720 and 1722 can be programmed via a network 1707. In various embodiments, the programmer 1724 broadcasts information and the electronics units 1716, 1718, 1720 and 1722 receive the information and control illumination of EL lamps of the EL modules 1702, 1704, 1706 and 1708 based on the information. In various embodiments, an animation program can be stored in one electronics unit and disseminated to the others via a network.

The programmer 1724 can be a custom computer or an off-the-shelf computer. The programmer 1724 may include a processor and a memory and a program stored in the memory that is executable by the processor. The programmer 1724 may also include a communications device, such as a network interface card, that can encode the program into a signal that can be read by the electronics units 1716, 1718, 1720 and 1722. The nodes illustrated in communications circuit 1710 may include information routing devices such as packet routers in various embodiments. The communications circuit 1710 may transmit networked information in some examples, such as over a Controller Area Network (CAN) bus or another kind of network. Other communications are possible, such as further multiplexed communications. The data that is communicated can include power on and power off signals, as well as animations signals such as those set out above. The programmer 1724 can program a plurality of controller devices simultaneously or sequentially. Communication over the network 1707 can be duplex.

In various embodiments, the programmer 1724 can provide animation information to the electronics units 1716, 1718, 1720 and 1722 in real time so that the controller devices of the electronic units can control the switch modules to switch power to EL lamps according to an animation program stored in the programmer 1724.

In various embodiments, electronics units 1716, 1718, 1720 and 1722 each are continuously supplied with power via first 1712 and second 1714 power circuits, and switch on or off an EL lamp according to a signal provided over communications circuit 1710.

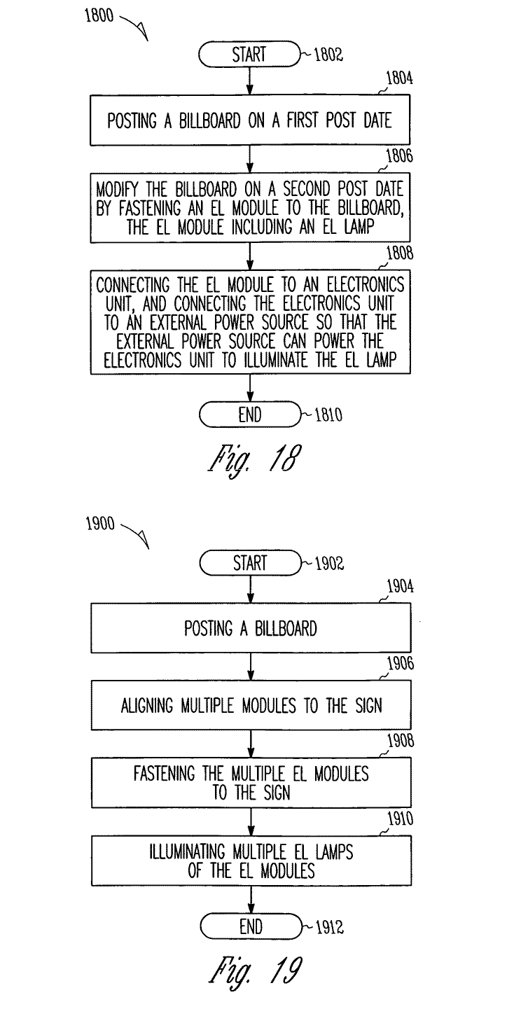

FIGS. 18 and 19 illustrate methods according to some embodiments. These methods are used to modify a billboard by adding or removing EL modules on different post dates. The methods optionally can provide a coordinate system for attachment of multiple EL modules such that an operator can easily locate the correct position for an EL module and affix that module to a billboard.

Method 1800 starts at 1802 in FIG. 18. At 1804, method 1800 includes posting a billboard on a first post date. At 1806, method 1800 includes modifying the billboard on a second post date by fastening an EL module to the billboard, the EL module including an EL lamp. At 1808, method 1800 includes connecting the EL module to an electronics unit, and connecting the electronics unit to an external power source so that the external power source can power the electronics unit to illuminate the EL lamp. Some embodiments also include illuminating the EL module. At 1810, method 1800 ends.

Method 1900 starts at 1902 in FIG. 19. At 1904, the method 1900 includes posting a billboard. At 1906, various embodiments include aligning multiple EL modules to the billboard. At 1908, method 1900 includes fastening the multiple EL modules to the billboard. At 1910, the method 1900 includes illuminating multiple EL lamps of the modules. At 1912, the method 1900 ends.

Various optional methods are contemplated. Some methods include animating one or more EL lamps of the EL modules by switching power to them as disclosed above in reference to FIG. 3. Some methods include individually fastening a plurality of EL modules to the billboard on one or more different post dates subsequent to the second post date. For example, a first EL module may be posted in on a first post date and a second EL module on a subsequent second post date.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. It is to be understood that the above description is intended to be illustrative, and not restrictive. Combinations of the above embodiments, and other embodiments, will be apparent to those of skill in the art upon reviewing the above description. The scope of the invention includes any other applications in which the above structures and fabrication methods are used. The scope of the invention should be determined with reference to the appended claims, along with the full scope of equivalents to which such claims are entitled.

1. An electroluminescent (EL) module to be affixed to a billboard comprising sign indicia, the EL module comprising:
an EL lamp;
a module frame coupled to the EL lamp to support the EL lamp, the module frame being less flexible than the EL lamp; and
an electronics unit coupled to the module frame, the electronics unit including:
a controller device to be coupled to a programmer, the controller device to communicate animation information with the programmer and to illuminate the EL lamp based on the animation information; and
a power inverter to be coupled to an external power source to convert power from the external power source into EL power to illuminate the EL lamp.

2. The apparatus of claim 1, wherein the controller device is to control a switch module to switch power to the EL lamp based on an animation program stored in the controller device.

3. The apparatus of claim 1, wherein the EL module includes alignment pointers to be aligned with alignment markers of the billboard.

4. The apparatus of claim 3, wherein the EL module includes a low tack adhesive and a high tack adhesive that is disposed around a perimeter of the low tack adhesive.

5. The apparatus of claim 1, wherein the EL module includes EL module graphics that comprises an approximate visual duplicate of the sign indicia of the billboard when the EL lamp is in a non-illuminated state.

6. The apparatus of claim 1, wherein the sign indicia is disposed along an opaque portion of the billboard and the EL module is to mask the opaque portion and to shine away from a surface of the billboard on which the sign indicia is disposed.

7. A system, comprising:
a billboard comprising sign indicia; and
a plurality of individually affixable electroluminescent (“EL”) modules affixed to the billboard, each EL module including at least one EL lamp, with at least one EL module including a controller device to be coupled to a programmer, the controller device to communicate animation information with the programmer and to illuminate each EL lamp based on the animation information.

8. The system of claim 7, wherein each EL module includes an electronics unit that includes the controller device, each electronics unit further including a power inverter to convert power from a municipal power grid into EL power to illuminate the EL lamp.

9. The system of claim 7, wherein the billboard further comprises alignment markers, and the plurality of EL modules are in alignment with the alignment markers.

10. The system of claim 9, wherein the alignment markers are disposed on the billboard according to regular repeating coordinates, and the plurality of EL modules are affixed to the billboard in alignment with the coordinates.

11. The system of claim 7, further comprising the programmer coupled to a controller device for each EL module, the programmer including
a processor;
a memory coupled with the processor, the memory including an animation program including the animation information; and
a network interface device to communicate the animation program to each controller device.

12. The apparatus of claim 7, wherein at least one EL module includes a module frame that is more stiff than an EL lamp affixed to the module frame.

13. The apparatus of claim 12, wherein the module frame is as flexible as the billboard.

14. A method, comprising:
posting a billboard on a first post date;
modifying the billboard on a second post date by fastening an EL module to the billboard, the EL module including an EL lamp; and
connecting the EL module to an electronics unit, and connecting the electronics unit to an external power source so that the external power source can power the electronics unit to illuminate the EL lamp.

15. The method of claim 14, wherein modifying includes aligning the EL module so that the EL lamp shines through an at least semi-transparent portion of the billboard.

16. The method of claim 14, further comprising connecting a controller device of the electronics unit to a programmer.

17. The method of claim 16, further comprising programming the controller device with an animation program using the programmer.

18. The method of claim 16, further comprising fastening a plurality of EL modules to the billboard, each having a respective electronics unit, and programming a plurality of controller units of the respective electronics units simultaneously.

19. The method of claim 16, further comprising fastening a plurality of EL modules to the billboard and providing EL module animation by switching power to EL lamps of each of the EL modules.

20. The method of claim 19, wherein providing EL module animation includes storing an animation program in at least one electronics unit and switching power to an EL lamp according to the animation program.
